(19) United States
(12) Patent Application Publication
(10) Pub. No.: US 2011/0213551 A1
(43) Pub. Date: Sep. 1, 2011

(54) ON-BOARD DEVICE, ROUTE GUIDANCE SYSTEM, METHOD FOR CONTROLLING COMMUNICATION OF ON-BOARD DEVICE, AND COMPUTER PROGRAM THEREFOR

(75) Inventors: Takehiko Shioda, Kawasaki (JP); Akihiro Tozaki, Kawasaki (JP); Kunihiro Minoshima, Kawasaki (JP); Kazunori Hashimoto, Tokyo (JP); Nobuhiro Ishizuka, Kanagawa (JP); Ken Murayama, Kawasaki (JP); Junichi Shirakawa, Nara (JP); Nobuo Kusumoto, Chiba (JP); Shuji Daioku, Hiroshima (JP)

(73) Assignees: PIONEER CORPORATION, Kanagawa (JP); SHARP KABUSHIKI KAISHA, Osaka (JP)

(21) Appl. No.: 13/062,642

(22) PCT Filed: Jul. 30, 2009
(86) PCT No.: PCT/JP2009/003618

§ 371 Date: May 16, 2011

(30) Foreign Application Priority Data
Sep. 5, 2008 (JP) 2008-228657

(51) Int. Cl. G01C 21/00

(52) U.S. Cl. 701/201

(57) ABSTRACT

An on-board device 10 of the invention has: a destination setting unit 110 with which a destination is set; a route guidance unit 130 that provides route guidance for a vehicle until a parking location that corresponds to the destination; a destination information transmitter 140 that transmits destination information indicating the destination to a portable device 30; and an arrival confirmation information receiver 160 that receives from the portable device 30 arrival confirmation information indicating that the destination has been reached. The route guidance unit 130 ends the route guidance for the vehicle to the parking location when the destination information has been transmitted or the arrival confirmation information has been received.

### TECHNICAL FIELD

The present invention relates to an on-board device that provide route guidance for a vehicle by coordinating with a portable device that provides route guidance for a person, a route guidance system, a method for controlling communication of the on-board device and a computer program therefor.

### BACKGROUND ART

In recent years, route guidance systems in which a portable device (for example, a portable telephone) and an on-board device (for example, a car navigation apparatus) are coordinated with each other to guide through a route to a destination have been known. In such systems, the on-board device, upon entering a parking lot, generates and sends route guidance information showing the route from the present location to the destination to the information center, and the portable device receives the route guidance information from the information center and guides through the route to the destination (see Patent Document 1). Such route guidance systems are convenient in such a way that, for example, even when there is no parking lot near the destination (when the vehicle cannot be guided to the destination), the user can follow the guidance of the portable device for the rest of the route to the destination on foot without getting lost even in a place new to the user.

### [Patent Document 1] JP-A-2002-257579

### SUMMARY OF THE INVENTION

### Problems to be Solved

With related art systems, on-board devices in general are configured to temporarily pause route guidance when the engine of the vehicle is turned off before arriving at the destination, and to start the route guidance again from the present position (parking lot) to the destination when the engine is restarted. Despite the fact that the user has arrived at the destination by following the guidance of the portable device, the route guidance systems may restart the route guidance when the user who left the vehicle comes back to the parking lot and starts driving. Thus, it is bothersome that the user needs to manually terminate the route guidance when he/she returns to the vehicle.

In view of the above-described problems, the present invention provides an on-board device that requires no operation for terminating the route guidance of the on-board device when the destination has already been reached according to the guidance of a portable device, and also provides a route guidance system, a method for controlling communication of the on-board device, and a computer program therefor.

### Means to Solve the Problems

An on-board device according to an aspect of the invention includes a destination setting unit with which a destination is set, a route guidance unit that provides route guidance for a vehicle until a parking location that corresponds to the destination, a destination information transmitter that transmits destination information indicating the destination to a portable device, and an arrival confirmation information receiver that receives from the portable device arrival confirmation information indicating that the destination has been reached, in which the route guidance unit ends the route guidance for the vehicle to the parking location when the destination information has been transmitted or the arrival confirmation information has been received.

A method for controlling communication of an on-board device according to another aspect of the invention is a method for controlling communication of an on-board device providing route guidance for a vehicle by coordinating with a portable device providing route guidance for a person. The method performed by the on-board device includes setting a destination, providing route guidance for the vehicle until the vehicle arrives at a parking location corresponding to the destination, transmitting destination information indicating the destination to the portable device, receiving from the portable device arrival confirmation information indicating that the destination has been reached, and ending the route guidance for the vehicle to the parking location after transmitting the destination information or receiving the arrival confirmation information.

These configurations allow for route guidance for a vehicle to end upon reception of the arrival confirmation information from the portable device. Therefore, no operation for terminating the route guidance is necessary on the on-board device. The fact that the destination information indicating the destination set on the on-board device has been transmitted in the first place means a situation where the vehicle cannot access the destination. In this case, the user may successfully reach the destination using a route guidance function of the portable device. Accordingly, if the destination information is transmitted to the portable device or the arrival confirmation information indicating that the destination has been reached is received from the portable device, the route guidance of the on-board device is no longer necessary. Automatically ending the route guidance saves the effort in manually canceling the route guidance, bringing improved convenience of the route guidance in coordination with the portable device.

It is noted that the “arrival confirmation information” may be information indicating that the portable device (the user of the portable device) has actually arrived at the destination, or that the user possessing the portable device has performed a predetermined operation. In the former case, the portable device determines whether the user has actually arrived at the destination based on the present location information acquired through a GPS receiver or the like and the destination information received from the on-board device. In the latter case, despite whether the user has actually arrived at the destination, the portable device determines that the user has arrived at the destination when the user performs the predetermined operation. In other words, the on-board device receives a result of the determinations of the portable device as “arrival confirmation information”.

The “on-board device” is a concept that includes not only a device provided to a vehicle in a fixed manner, but also a device provided to a vehicle in a detachable manner (a portable on-board device).

The “parking location” indicates the destination of the on-board device, and the “destination” and the “parking location” may indicate the same place.

Optionally, in the on-board device, the destination information transmitter sends the destination information upon pause of the route guidance for the vehicle.

In general, the user parks the vehicle to use another means of transportation for the rest of the route when the user cannot access the destination by vehicle. Thus, using the pause of the route guidance for the vehicle (such as turning the engine off) as a trigger enables the transmission of the destination information to the portable device at an appropriate timing. It is noted that pause of the route guidance is performed specifically when the engine of the vehicle has stopped, the on-board device is operated to turn off, or the on-board device has received an instruction to pause the route guidance.

Optionally, the on-board device further includes a start instruction transmitter that transmits to the portable device a start instruction of a route guidance function for a person before the destination information is sent by the destination information transmitter.

Such configuration allows for saving the user the effort in starting the route guidance function (a route guidance application) on the portable device before the destination information is sent from the on-board device.

Optionally, the on-board device, with the portable device also having a destination setting function for setting a destination, further includes a destination information receiver that receives from the portable device the destination information set by the destination setting function, and a termination instruction transmitter that transmits to the portable device a termination instruction for terminating the route guidance function upon receiving the destination information. The destination setting unit sets the destination based on the destination information received.

Such configuration allows for performing route guidance based on the destination information set on the portable device. This enables the driver to set destination information on the portable device before boarding the vehicle and to start the route guidance immediately after boarding the vehicle. Moreover, the fact that the destination information has been sent to the on-board device from the portable device means that the route guidance of the portable device is no longer necessary. Transmitting the termination instruction of the route guidance function to the portable device upon receiving the destination information saves the user the effort in terminating the route guidance function on the portable device.

Optionally, the on-board device further includes a coordination selection unit with which whether to perform a coordination process with the portable device is selected. The destination information transmitter transmits the destination information when performing the coordination process is selected in the coordination selection unit.

Such configuration allows for selecting whether to coordinate with the portable device based on the user's needs.

Optionally, the on-board device further includes a present location information acquisition unit that acquires present location information indicating a present location. The destination information transmitter transmits the destination information when a distance between the present location where the route guidance for the vehicle is paused and the parking location is within a predetermined distance.

Such configuration allows for transmitting the destination information if the distance between the present location where the route guidance for a vehicle is paused and the parking location (the destination of the on-board device) is within the predetermined distance, and thus prevents transmitting unnecessary destination information. In other words, if the present location where the route guidance for the vehicle is terminated (the location where the vehicle is parked) is far from the parking location (too far to travel for the rest of the route on foot), it is determinable that the vehicle is parked for a rest or a stop off. Not transmitting the destination information in this case brings improved convenience in the route guidance in coordination with the portable device.

Optionally in the on-board device, the destination information transmitter transmits the destination information and the present location information indicating the present location where the route guidance for the vehicle is paused.

Such configuration allows for transmitting the present location information indicating the present location where the route guidance for the vehicle is paused, and thus registering the parking location and the like of the vehicle on the portable device. With such configuration, the user, who arrived at the destination, will not get lost in the way back to the vehicle, or wander around to look for the vehicle as he/she has forgotten the parking location.

Optionally in the on-board vehicle, the route guidance unit uses an operation of turning the on-board device off or the vehicle's engine stop during the route guidance for the vehicle as a trigger to pause the route guidance, and the destination information transmitter transmits the destination information before the on-board device is deactivated due to the operation of turning off or the engine stop.

Such configuration allows for easily and assuredly detecting the pause of the route guidance from the operation of turning off or the engine stop of the vehicle. Moreover, the destination information is transmitted before the on-board device is deactivated due to the operation of turning off or the engine stop, and thus the destination information will not remain unsent.

Optionally in the on-board device, the destination information transmitter transmits the destination information when the parking location is not any of pre-registered places.

Such configuration allows for not transmitting the destination information if the parking location is not any of pre-registered places, and thus preventing unnecessary information from being sent. For example, if a pre-registered place is the user's school, workplace or home, it is highly unlikely that the user would need route guidance of the portable device to get there. In other words, it is convenient that, even when the route guidance is paused near the home or the like (within the predetermined distance from the destination), the destination information will not be sent to the portable device.

A route guidance system according to another aspect of the invention includes the on-board device described above and the portable device.

A computer program according to still another aspect of the invention causes a computer to execute each step of the method for controlling communication of an on-board device.

Such configuration allows for providing a route guidance system or a computer program that requires no operation for terminating the route guidance of the on-board device when the destination has already been reached according to the guidance of the portable device.

### BRIEF DESCRIPTION OF THE DRAWINGS

FIG. 1 is a control block diagram of an on-board device according to a first embodiment of the invention.

FIG. 2 is a functional diagram of a route guidance system.

FIG. 3 is a diagram showing an example of a selection screen for selecting whether to request a coordination process.

FIG. 4 is a diagram showing an example of a determining method of a predetermined distance based on distribution condition of a parking lot.

FIG. 5 is a flowchart showing operations of the on-board device.

FIG. 6 is a flowchart continued from FIG. 5.

FIG. 7 is a sequential diagram showing a coordination process of the on-board device and a portable device.

FIG. 7 is a sequential diagram continued from FIG. 7.

### BEST MODES FOR CARRYING OUT THE INVENTION

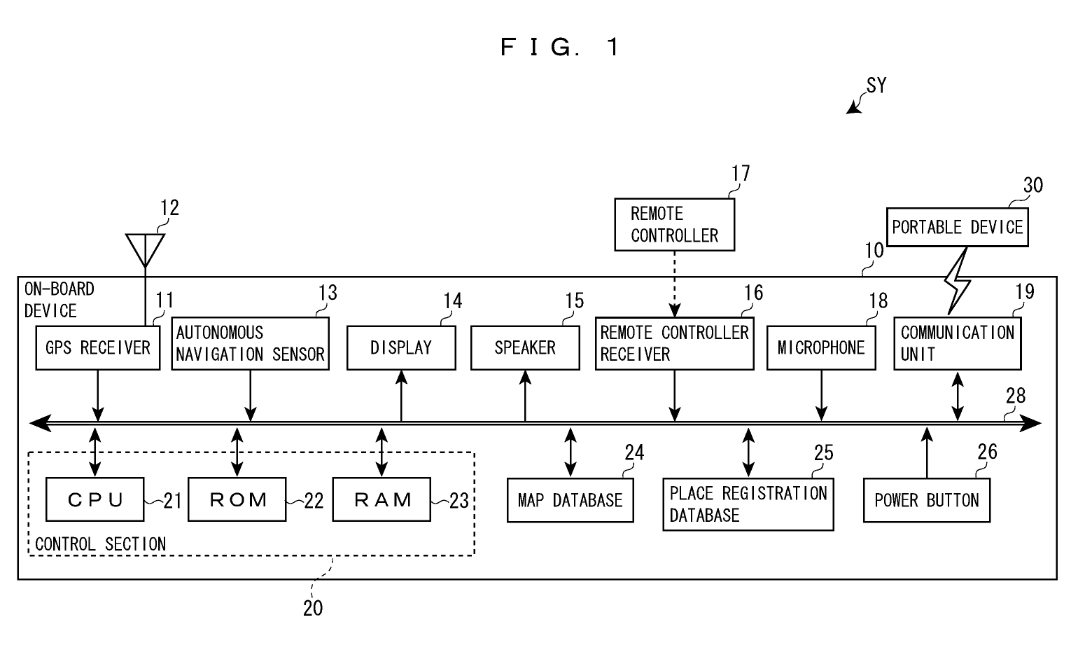

An on-board device, a route guidance system, a method for controlling communication of the on-board device, and a computer program therefor according to a first embodiment of the invention will be described below. FIG. 1 is a control block diagram of an on-board device 10. As shown in the figure, the on-board device 10 includes a GPS (Global Positioning System) receiver 11, an antenna 12, an autonomous navigation sensor 13, a display 14, a speaker 15, a remote controller optical receiver 16, a remote controller 17, a microphone 18, a communication section 19, a control section 20, a map database 24, a place registration database 25, a power button 26, and a connection BUS 28.

The GPS (Global Positioning System) receiver 11 receives GPS information (including location information and time information) via the antenna 12. The autonomous navigation sensor 13 is constituted of an angular sensor and a distance sensor (both not shown in the figure) and used to specify a present vehicle location in combination with the GPS receiver 11. The display 14 displays route guidance information, as well as various setting or selection dialogues as needed. The speaker 15 outputs audio route guidance information.

The remote controller optical receiver 16 obtains operational signals from the remote controller 17. The remote controller 17 is used to perform various operations using an operation element, and is used mainly for inputting information in response to the various setting or selection dialogues. The microphone 18 is used to conduct a hands-free conversation, if a portable device 30 is a portable telephone. Moreover, the microphone 18 is also used for hands-free audio input to perform various operations.

The communication section 19 performs near field communication or infrared communication with the portable device 30. It is noted that Bluetooth (registered trademark), ZigBee (registered trademark) or UWB (Ultra Wide Band) may be employed for a communication method for near field communication, or wireless IEEE802.11 such as Wi-Fi (registered trademark). It is further noted that the communication section 19 may conduct wired communication using a connection such as BUS without employing such contactless communication. The control section 20 is constituted of a CPU (Central Processing Unit) 21, a ROM (Read Only Memory) 22 and a RAM (Random Access Memory). The CPU 21 is a central processor and performs various computations. The ROM 22 stores a control program for performing various computations by the CPU 21, and the RAM 23 is used as a work area for performing various computations by the CPU 21.

The map database 24 stores map information used for route guidance. The place registration database 25 stores place registration information registered as registered places, and generally the places the user visits frequently, or the places set as destinations in the past are registered as place registration information. It is noted that the on-board device 10 of the present embodiment is capable of distinguishably registering certain places (the user's work place, school or home, etc.), and those certain places are hereinafter referred to as “predetermined registered places”.

The power button 26 is an operational element that turns operations of the on-board device 10 on or off. It is noted that the power button 26 may be turned on or off in coordination with a start position of the engine key (example: accessories on) of the vehicle. A power source of the on-board device 10 is connected to the battery of the vehicle and is conductive regardless of a state of the engine or engine key. It is noted that an “engine stop” hereinafter indicates a state of the engine of the vehicle being turned off, and does not indicate a state of the on-board device 10 having stopped operating. In other words, the on-board device 10, in response to a stop signal from the engine of the vehicle, proceeds to a shut-down process and then to a state of operations being turned off. Similarly, the on-board device 10, in response to an operation of turning off at the power button 26, proceeds to a shut-down process and then to a state of operations being turned off.

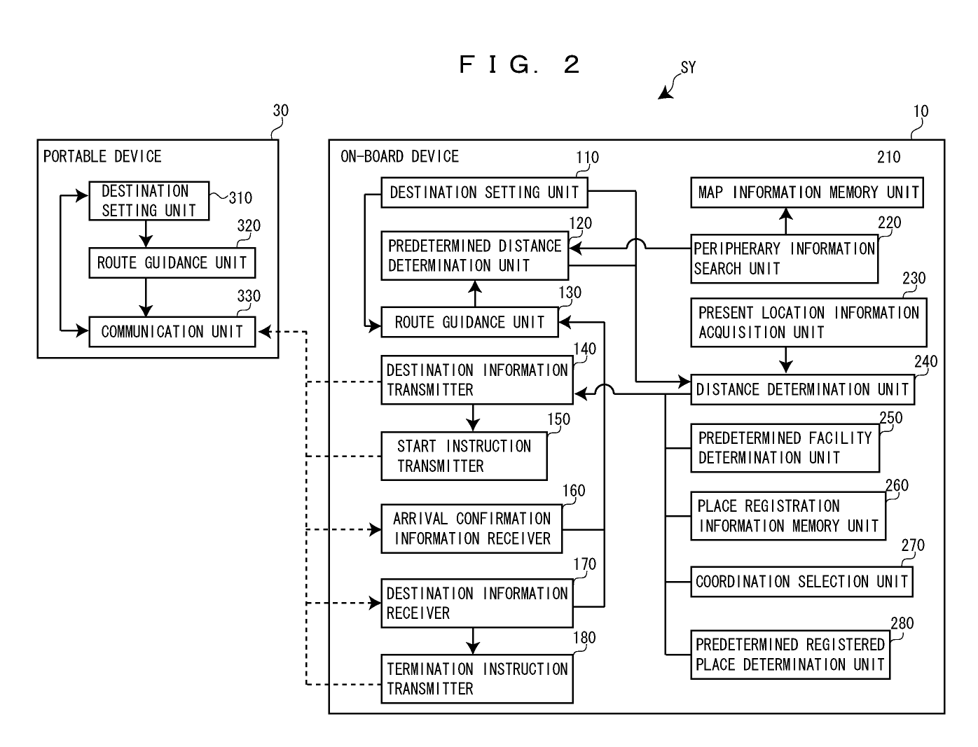

Next, a functional configuration of a route guidance system SY constituted of the on-board device 10 and the portable device 30 will be described with reference to FIG. 2. As a functional configuration, the portable device 30 mainly includes a destination setting unit 310 (destination setting function), a route guidance unit 320 (route guidance function) and a communication unit 330.

The destination setting unit 310 sets a destination of the route guidance (also referred to as a “final destination”). It is noted that the destination set may be transmitted to the on-board device 10 as destination information. This enables the driver to set the destination using the portable device 30 before boarding the vehicle and to start the route guidance immediately after boarding the vehicle by transmitting the destination information to the on-board device 10. It is noted that the destination transmitted to the on-board device 10 may be not only an arbitrary place represented by latitude and longitude, but also a facility name, a telephone number, and etc.

The route guidance unit 320 provides route guidance to the destination set by the destination setting unit 310. In this case, the route guidance is provided through displaying the route guidance information and/or outputting the route guidance information in audio. Accordingly, the route guidance unit 320 is a concept that includes a display unit and an audio output unit. It is noted that the route guidance unit 320 is also capable of guiding through the route to the destination based on the destination information transmitted from the on-board device 10. The details will be described later below.

The communication unit 330 inputs/outputs (sends/receives) information to and from the on-board device 10 and is mainly used for sending/receiving destination information or transmitting arrival confirmation information (the information indicating that the user possessing the portable device 30 has actually arrived at the destination). It is noted that the arrival confirmation information is transmitted when the portable device 30 determines, based on the present location information acquired from the GPS receiver and etc., to have actually arrived at the destination specified in the destination information received from the on-board device 10.

Next, a functional configuration of the on-board device 10 will be described. As a functional configuration, the on-board device 10 mainly includes a destination setting unit 110, a predetermined distance determination unit 120, a route guidance unit 130, a destination information transmitter 140, a start instruction transmitter 150, an arrival confirmation information receiver 160, a destination information receiver 170, a termination instruction transmitter 180, a map information memory unit 210, a periphery information search unit 220, a present location information acquisition unit 230, a distance determination unit 240, a predetermined facility determination unit 250, a place registration information memory unit 260, a coordination selection unit 270 and a predetermined registered place determination unit 280.

The destination setting unit 110 sets a destination (final destination) for route guidance, and includes the control section 20, the display 14, the speaker 15, the remote controller 17 and the microphone 18 as main configuration elements. The destination information indicating the destination set by the destination setting unit 110 can be transmitted, as described above, to the portable device 30. The destination setting unit 110 is also capable of setting a destination based on the destination information received from the portable device 30.

The predetermined distance determination unit 120 determines a predetermined distance X used for determining a “distance”, which is one of conditions for transmission for transmitting the destination information to the portable device 30. The predetermined distance determination unit 120 includes the control section 20 as a main configuration element. The on-board device 10 of the present embodiment presumes a situation in which it is difficult to get to the destination with the vehicle, and transmits the destination information (instructs to guide the rest of the route to the destination) to the portable device 30 when the route guidance is paused. However, when the vehicle stops for a rest, the on-board device 10 is configured not to unnecessarily send instructions for the portable device 30 to guide the route. Thus, the on-board device 10 determines whether the vehicle has stopped for a rest or for a difficulty in arriving at the destination in the vehicle based on whether the parking location is more than the predetermined distance X away from the destination.

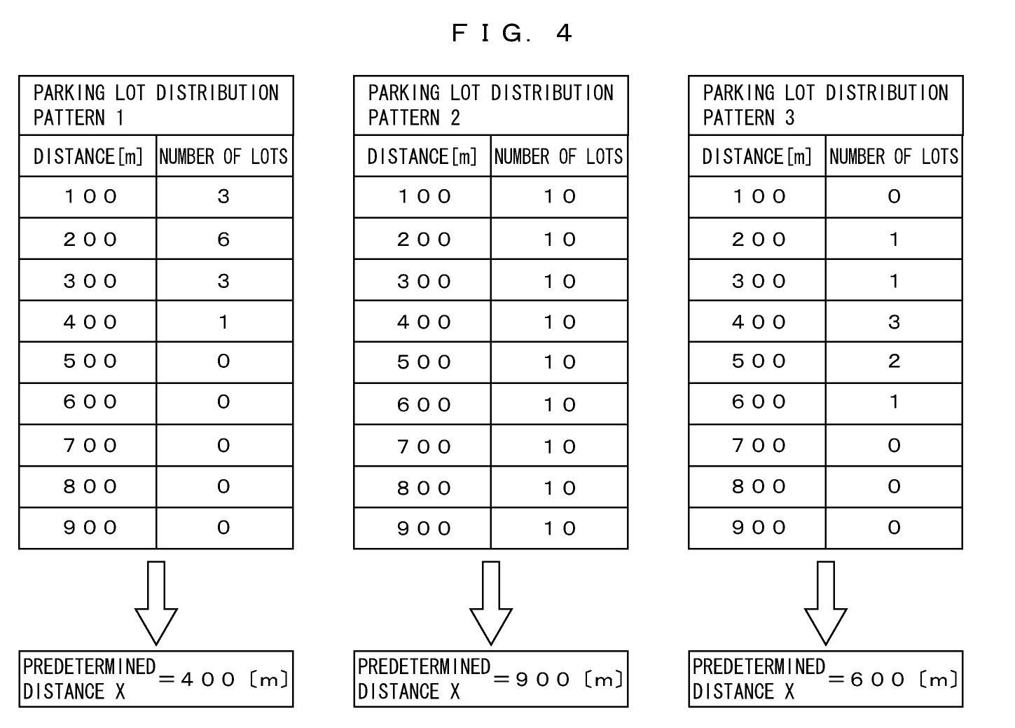

The predetermined distance determination unit 120 determines the predetermined distance X based on a search result of the periphery information search unit 220 (which includes the control section 20 as a main configuration element). In other words, the periphery information search unit 220, along with a determination of a parking location (hereinafter also referred to as a “car navigation destination”) made by the route guidance unit 130 to be described later below, searches the periphery of the parking location from the map information stored in the map information memory unit 210 (which includes the map database 24 as a main configuration element). Specifically, the periphery information search unit 220 searches the distribution condition of the parking lot (parking facility) around the car navigation destination from the map information, and if the distribution is on a broad area, the predetermined distance determination unit 120 sets a longer predetermined distance. If the distribution of the parking lot is centralized on an area around the car navigation destination, the predetermined distance determination unit 120 sets a shorter predetermined distance. It is noted that details of a method for determining the predetermined distance X will be described later below with reference to FIG. 4. It is further noted that a “car navigation destination” includes an arbitrary place itself represented by latitude and longitude, a map code, an address, a telephone number or other information that may indirectly indicate the arbitrary place.

The route guidance unit 130 determines a parking location, which corresponds to the destination set by the destination setting unit 110 (or the destination setting unit 310 on the portable device 30), as a car navigation destination, searches for the route to the car navigation destination, and provides the route guidance (displaying the route guidance and audio guidance) for the vehicle. The route guidance unit 130 includes the GPS receiver 11, the autonomous navigation sensor 13, the display 14, the speaker 15, the control section 20 and the map database 24 as main configuration elements. It is noted that the car navigation destination (parking location) determined by the route guidance unit 130 may be a location associated to the final destination set by the destination setting unit 110, or the final destination set by the destination setting unit 110 itself. It is noted that the route guidance unit 130 pauses the route guidance given that the on-board device 10 is turned off (a pressing operation in the power button 26) or the engine of the vehicle is turned off as a trigger in the middle of the route guidance for a vehicle.

The destination information transmitter 140 transmits destination information indicating a destination set by the destination setting unit 110 to the portable device 30, and includes the control section 20 and the communication section 19 as main configuration elements. It is noted that the start instruction transmitter 150, the arrival confirmation information receiver 160, the destination information receiver 170 and the termination instruction transmitter 180 include the control section 20 and the communication section 19 as main configuration elements. The destination information transmitter 140 transmits the destination information when four conditions for transmission are satisfied. The four conditions for transmission is a “distance”, a “predetermined facility”, a “predetermined registered place”, and a “coordination process”.

Firstly, one of the conditions for transmission, the “distance” will be described. The destination information transmitter 140 transmits the destination information to the portable device 30 when the distance determination unit 240 (including the control section 20 as a main configuration element) determines that the distance between the present location of the vehicle and the car navigation destination is within the predetermined distance X. The distance determination unit 240 determines whether the distance between the present location of the vehicle and the car navigation destination is within the predetermined distance X, which is determined by the predetermined distance determination unit 120, when the route guidance for a vehicle by the route guidance unit 130 is paused. It is noted that the present location is specified based on the present location information acquired by the present location information acquisition unit 230 (including the GPS receiver 11 as a main configuration element).

Next, another one of the conditions for transmission, the “predetermined facility” will be described. The destination information transmitter 140 transmits the destination information when the present location (based on the present location information acquired by the present location information acquisition unit 230) when the route guidance is paused is not determined to be inside a predetermined facility as a result of the determination made by the predetermined facility determination unit 250 (including the control section 20 as a main configuration element). The predetermined facility determination unit 250 determines whether the present location of the vehicle is determined to be inside the predetermined facility when the route guidance for a vehicle by the route guidance unit 130 is paused. It is noted that the predetermined facility indicates a rest area, a roadside station or other rest facilities used for rest breaks from driving. That is, if the present location where the route guidance for a vehicle is paused is in a rest area, rest areas are rarely set as a car navigation destination. The pause of the route guidance for a vehicle in such a facility is determined to be for a rest, and the destination information is not transmitted. Hence, it is convenient that, even when the vehicle is stopped in a rest area near the destination (within the predetermined distance X from the car navigation destination), unnecessary information (the destination information) will not be sent to the portable device 30.

Next, another one of the conditions for transmission, the “predetermined registered place” will be described. The destination information transmitter 140 transmits the destination information when the car navigation destination is not any of predetermined registered places, which are pre-registered in advance, based on the determination result of the predetermined registered place determination unit 280 (including the control section 20 as a main configuration element). In other words, if the car navigation destination is one of the predetermined registered places registered in advance, the predetermined registered place determination unit 280 proceeds the on-board device 10 to a normal operation not operating in coordination with the portable device 30 are. Whether the car navigation destination is one of the predetermined registered places is determined based on a reference result of the place registration information memory unit 260 (including the place registration database 25 as a main configuration element). In other words, concerning the predetermined registered places (certain places including the user's school, workplace, or home), it is highly unlikely that the user would need route guidance of the portable device 30 to get to such places. Hence, it is convenient that, even when the route guidance is paused near the home or the like (within the predetermined distance X from the car navigation destination), the destination information will not be sent to the portable device 30.

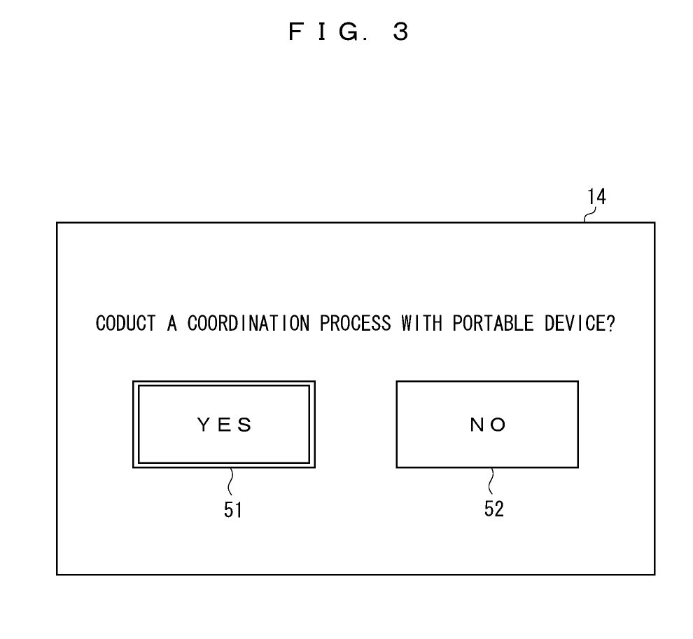

Next, another one of the conditions for transmission, the “coordination process” will be described. The destination information transmitter 140 transmits the destination information only when a coordination process is selected to be performed by the coordination selection unit 270 (including the control section 20, the display 14, the speaker 15, the remote controller and the microphone 18 as main configuration elements). The coordination selection unit 270, after either the destination is set by the destination setting unit 110 or the destination information is received by the destination information receiver 170, displays a selection dialogue on the display 14 to prompt the user for a selection of whether to coordinate with the portable device 30 or outputs selection information from the speaker 15. FIG. 3 is diagram showing an example of the selection dialogue. The user selects whether to conduct a coordination process with the portable device 30 by selecting either an icon 51 or an icon 52 displayed on the selection dialogue using the remote controller 17 or the microphone 18. It is noted that the coordination selection unit 270 can set whether to conduct a coordination process in advance, not after the destination is set (the car navigation destination is determined), in an environment setting or the like.

The destination information transmitter 140, when the route guidance for a vehicle is ended, determines whether the car navigation destination and the final destination match, and if the two do not match and the four conditions for transmission above are satisfied, the destination information transmitter 140 transmits the destination information. It is noted in the present embodiment that the destination information transmitter 140, when transmitting the destination information, also transmits the present location information indicating the present location where the route guidance for a vehicle is paused. With such configuration, the user, who has arrived at the destination according to the route guidance of the portable device 30, will not get lost in the way back to the vehicle, or wander around to look for the vehicle because he/she has forgotten the parking location.

The on-board device 10 may end the route guidance after the on-board device 10 has transmitted the destination information to the portable device 30. After the destination information has been transmitted to the portable device 30, the user approaches to the destination without using the vehicle, and thus the route guidance on the on-board device 10 is no longer necessary. In such a case, automatically ending the route guidance saves the effort in manually canceling the route guidance, bringing improved convenience of the route guidance in coordination with the portable device 30.

The start instruction transmitter 150 transmits to the portable device 30 a start instruction of the route guidance unit 320 (an instruction to start the route guidance application) before the destination information is transmitted by the destination information transmitter 140. It is noted that, the portable device 30 may possibly be powered off, and thus a start instruction for starting operations to turn on the portable device 30 may also be transmitted along with the start instruction of the route guidance unit 320.

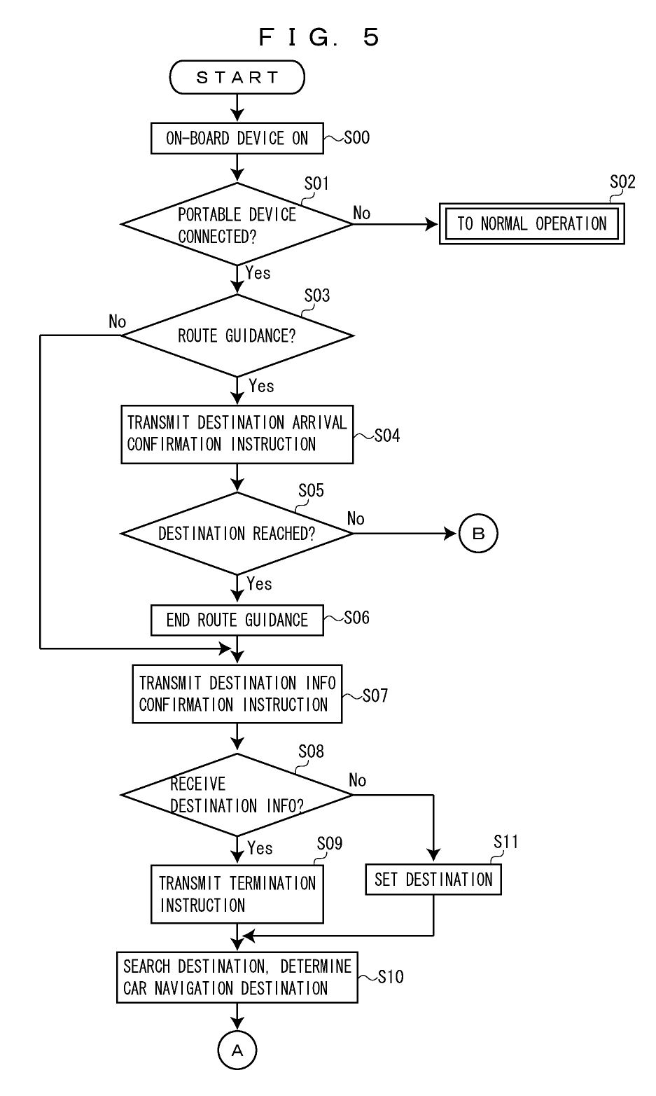

The arrival confirmation information receiver 160 receives from the portable device 30 arrival confirmation information indicating that the destination (final destination) has been reached. It is noted that the route guidance unit 130 above ends the route guidance for a vehicle when the arrival confirmation information receiver 160 receives the arrival confirmation information. In the description below, when the on-board device 10 determines that the route guidance is being performed after powered on, the on-board device 10 transmits an instruction for confirming arrival (see S04 in FIG. 5).

It is noted that the portable device 30 may include information that relates to the place of arrival (destination) to transmit as the arrival confirmation information. Such configuration allows for, when a plurality of destinations (stopovers) is set on the on-board device 10, ending the route guidance to the particular destination while continuing the route guidance to the other destinations.

The destination information receiver 170 receives the destination information from the portable device 30. The termination instruction transmitter 180, upon receiving the destination information at the destination information receiver 170, transmits to the portable device 30 termination instruction of the route guidance unit 320. In other words, the fact that the destination information has been sent to the on-board device 10 from the portable device 30 means that the route guidance of the portable device 30 is no longer necessary. Sending the termination instruction of the route guidance unit 320 to the portable device 30 upon receiving the destination information saves the user the effort in terminating the route guidance function on the portable device 30.

Next, details of a method for determining the predetermined distance X will be described below with reference to FIG. 4. The figure shows the detection results of a number of parking lots per predetermined unit distance (100 m). For example, in the case of <Parking Distribution Pattern 1>, three parking lots are present within a radius of 100 [m] from the car navigation destination (the parking location), and six parking lots, in addition to the above three within the 100 [m]-radius, are present within a radius of 200 [m] from the car navigation destination. In the examples of the figure, the detection results from a radius of 100 [m] to a radius of 900 [m] are respectively shown.

As for the method for determining the predetermined distance X, firstly, a distance prior to the distance in which the number of the parking lots is the smallest is determined as the predetermined distance X. In the case of <Parking Distribution Pattern 1>, the distance in which the number of parking lots is the smallest (“0” in this case) is 500 [m], and therefore the predetermined distance X is 400 [m].

If there is no distance in which the number of parking lots is the smallest, then the maximum distance is determined to be the predetermined distance X. Accordingly, in the case of <Parking Distribution Pattern 2>, the predetermined distance X is 900 [m].

Moreover, if the distance in which the number of parking lots is the smallest is near the car navigation destination (for example, within 300 [m] of distance), that destination is considered out of criteria. For determining the predetermined distance X, the distance in which the number of parking lots is the smallest from the detection results in the distance range between a certain distance away (400 [m]) from the car navigation destination and the maximum distance of 900 [m] is searched, and the distance prior to the distance with the smallest number of parking lots is determined to be the predetermined distance X. Accordingly, in the case of <Parking Distribution Pattern 3>, the predetermined distance X is 600 [m].

It is noted that, in the above example, the smallest number of parking lots is “0”, but the smallest number of parking lots may be set to be more than one. In this case, the predetermined distance X is 300 [m] in the example of <Parking Distribution Patten 1>, and the predetermined distance X is 500 [m] in the example of <Parking Distribution Pattern 3>.

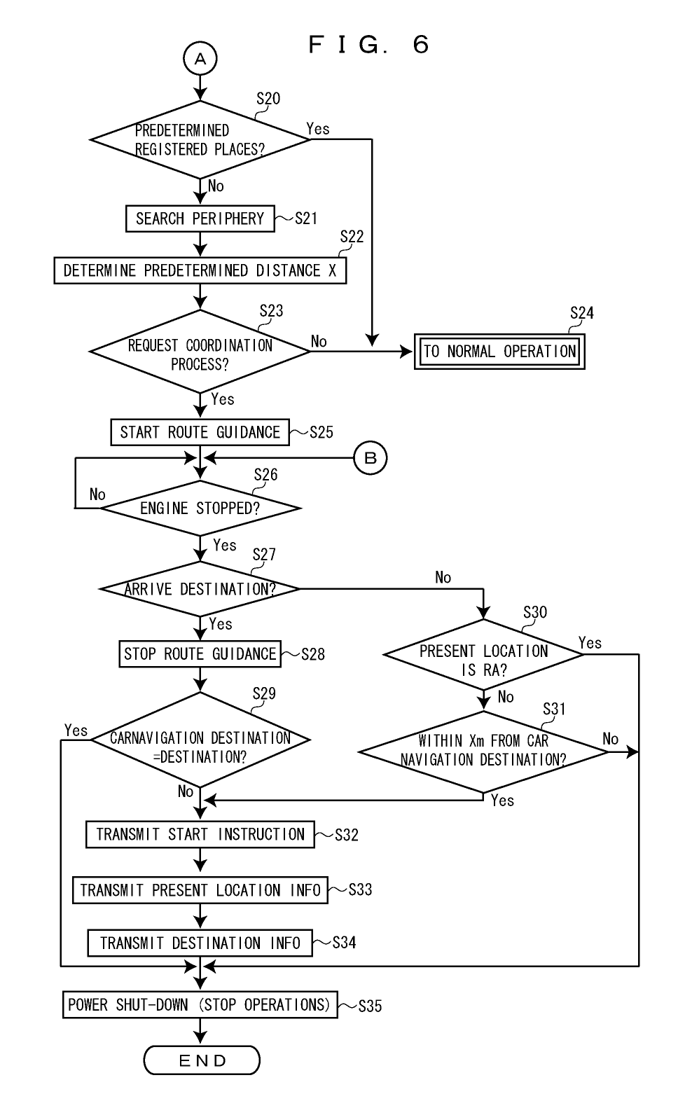

Next, operations of the on-board device 10 will be described with reference to the flowcharts of FIG. 5 and FIG. 6. As shown in FIG. 5, when powered on (S00) by an operation of the power button 26 or the engine start of the vehicle, the on-board device 10 determines whether the portable device 30 is connected (whether the communication is established) (S01). If the portable device 30 is not connected (S01: No), the on-board device 10 proceeds to normal operations (operations performed by the on-board device 10 alone) (S02).

If the portable device 30 is connected (S01: Yes), then the on-board device 10 determines whether the route guidance is being performed (S03). If the route guidance is being performed (S03: Yes), the on-board device 10 transmits to the portable device 30 an instruction for confirming arrival (S04). It is possible that the portable device 30 has arrived at the destination while the on-board device 10 is powered off, and the instruction for confirming arrival is there for that reason to check for a receipt of the arrival confirmation information indicating that the destination has been reached. If the on-board device 10, as a result of having transmitted the instruction for confirming arrival, confirms that the destination has been reached (S05: Yes), the on-board device 10 ends the route guidance (S06).

On the other hand, when it is determined that the route guidance is not being performed (S03: No), the on-board device 10 transmits to the portable device 30 an instruction for confirming destination information (S07). The instruction for confirming destination information is transmitted to check whether the portable device 30 has the destination information and has reserved a transfer of the destination information. If the on-board device 10, as a result of having transmitted the instruction for confirming destination information, has received the destination information (S08: Yes), the on-board device 10 transmits to the portable device 30 termination instruction of the route guidance unit 320 (S09). If the on-board device 10 does not receive the destination information (S08: No), the on-board device 10 sets the destination (S11).

After either the destination information is received or the destination is set, the on-board device 10 performs a destination search to determine a car navigation destination, which is the destination of the on-board device 10 (S10). The on-board device 10 may determine the nearest parking lot to the destination as the car navigation destination. In other words, the on-board device 10 may set a parking lot nearby the destination, not the destination itself, as the destination of the on-board device 10, depending on the destination. Hence the step S10 is required. If the on-board device 10 does not set a parking lot nearby the destination as the car navigation destination, the on-board device 10 determines the destination received in the step S08 or set in the step S11 as the car navigation destination.

As shown in FIG. 6, the on-board device 10, having determined the car navigation destination, determines whether the car navigation destination is any of the predetermined registered places (S20). If the car navigation is one of the predetermined registered places (S20: Yes), the on-board device 10 proceeds to the normal operation (S24). If the car navigation destination is not any of the predetermined registered places (S20: No), the on-board device 10 searches the periphery of the car navigation destination (S21) to determine the predetermined distance X (S22). The on-board device 10 refers to the map information in the map database 24 for searching the periphery, and specifically detects distribution of the parking lots.

The on-board device 10, having determined the predetermined distance X (S22), prompts the user for a selection whether to request a coordination process with the portable device 30 (S23). If the selection for not requesting it is selected (S23: No), the on-board device 10 proceeds to the normal operation (S24). If the selection for requesting it is selected (S23: Yes), the on-board device 10 proceeds to starting the route guidance (S25).

After that, when the route guidance is paused due to the engine stop of the vehicle or the like (26: Yes), the on-board device 10 determines whether the car navigation destination has been reached (S27). If it is determined that the car navigation destination has been reached, the on-board device 10 ends the route guidance. If the car navigation destination has not been reached (S27: No), the on-board device 10 determines whether the present location is any of the predetermined facilities like a rest area (S30). If the present location is not any of the predetermined facilities (S30: No), the on-board device 10 further determines whether the present location is within the predetermined distance X (m) from the car navigation destination (S31). If the present location is one of the predetermined facilities (S30: Yes) or is not within the predetermined distance from the car navigation destination (S31: No), the on-board device 10 performs a normal shut-down process to power off (shutting all operations off) the on-board device 10 without transmitting information such as the destination information (S35).

On the other hand, if the route guidance is ended at an arrival at the car navigation destination (S27: Yes, S28), the on-board device 10 determines whether the car navigation destination is the destination (destination of S08, S11) (S29). If the car navigation destination is the destination (S29: Yes), no further route guidance is necessary. Thus, the on-board device 10 performs a normal shut-down process to power off (shutting all operations off) the on-board device 10 (S35) without transmitting information such as the destination information. On the other hand, if the car navigation destination is not the destination (S29: No), or if the present location is not any of the predetermined facilities (S30: No) and is within the predetermined distance X [m]] from the car navigation destination (S31: Yes), the on-board device 10 transmits to the portable device 30 a start instruction of the route guidance unit 320 (S32). Then, the on-board device 10 transmits to the portable device 30 the present location information (the parking lot, etc.) (S33), the destination information (in this case the information indicating the destination of S08, S11) (S34), performs the normal shut-down process to power off (shutting all operations off) the on-board device 10 (S35).

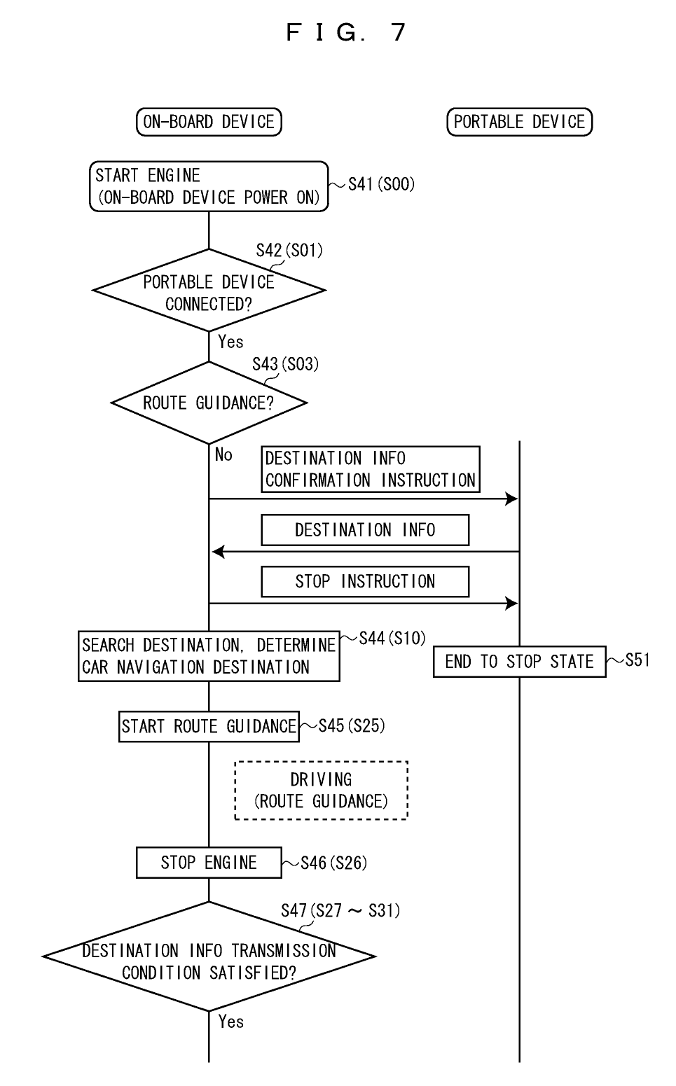

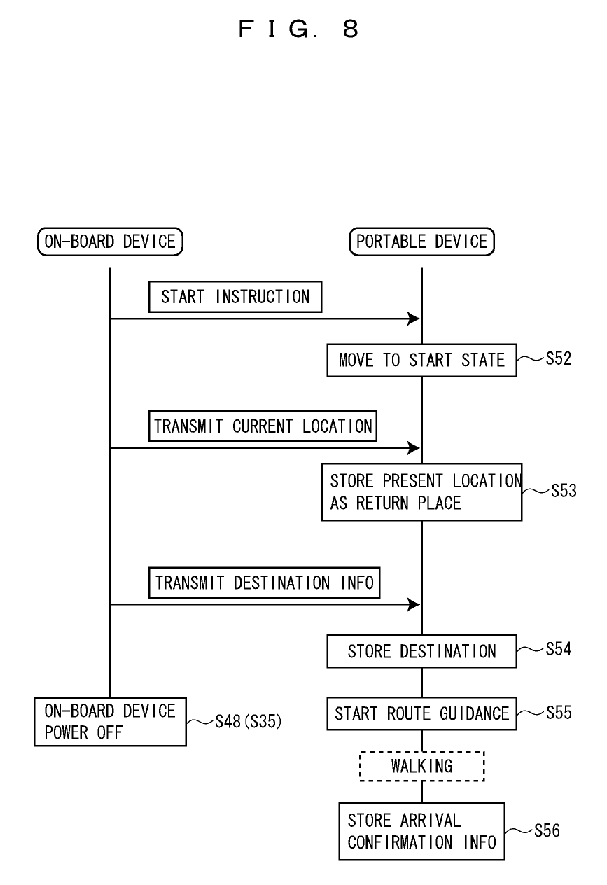

Next, a coordination process between the on-board device 10 and the portable device 30 will be described with reference to FIG. 7 and FIG. 8. It is noted that the description is given below, with reference to the sequential diagrams, around transactions of information between the on-board device 10 and the portable device 30 and operations of the portable device 30, because the operations of the on-board device 10 have already been described with reference to the flowcharts of FIG. 5 and FIG. 6. It is further noted that the numbers in parenthesis (S**) in FIG. 7 and FIG. 8 represent the step numbers of the operations of the on-board device 10 corresponding to the step numbers in the flowcharts of FIG. 5 and FIG. 6. It is still further noted that, among rectangular frames each representing a step in the sequential diagram, rounded rectangles represent the steps that involve user operations.

As shown in FIG. 7, the on-board device 10, having been powered on by an engine start of the vehicle (S41), confirms a connection with the portable device 30 (S42), and if the connection is confirmed (S42: Yes), the on-board device 10 determines whether the route guidance is being performed (S43). If no route guidance is being performed (S43: No), the on-board device 10 transmits to the portable device 30 the instruction for confirming destination information. When the portable device 30 transmits the destination information that has been set in response, the on-board device 10 transmits to the portable device 30 termination instruction for terminating the route guidance function. Then, the portable device 30 ends the route guidance function (route guidance unit 320) (S51).

The on-board device 10 performs a destination search based on the destination information received from the portable device 30, and determines a car navigation destination based on the search result (S44). Then, the on-board device 10 starts the route guidance (S45) and continues to guide through the route while traveling until the engine stops (the route guidance is paused). The on-board device 10, upon detecting the engine stop (S46), determines whether the conditions for transmission of the destination information are satisfied (S47). If the conditions for transmission are satisfied (S47: Yes), as shown in FIG. 8, the on-board device 10 transmits to the portable device 30 a start instruction of the route guidance function.

The portable device 30, upon receiving the start instruction from the on-board device 10, starts the route guidance function (S52), and, upon receiving the present location information from the on-board device 10, stores the present location information as a return place (S53), and, upon receiving the destination information from the on-board device 10, stores the destination (S54). The on-board device 10 will be powered off after transmitting these pieces of information (S48). The portable device 30 stores the destination and starts the route guidance to the destination (S55). It is noted that, it is assumed in the present embodiment that the portable device 30 has the route guidance function, however, the portable device 30 may not necessarily have that function. For example, the portable device 30 may simply display the destination information received from the on-board device 10, and the user may travel to the destination based on the displayed destination information. The “destination information” herein refers to a map on which the return place (parking location) and the final destination are displayed, for example.

When the user of the portable device 30 travels (walks) according to the route guidance and has finally arrived at the destination, the portable device 30 stores inside the portable device 30 arrival confirmation information, which indicates that the destination has been reached (S56), and ends the route guidance. It is noted that the on-board device 10 will be able to receive the arrival confirmation information at a start up, as the on-board device 10 confirms arrival (S05 in FIG. 5).

It is noted that, in the sequential diagrams shown in FIG. 7 and FIG. 8, the on-board device 10 performs the route guidance based on the destination information set in the portable device 30, however in this case, the information transmitted upon the pause of the route guidance (the engine stop) by the on-board device 10 may only be the present location information. In other words, having the portable device 30 to store the destination information omits transmitting the destination information upon the pause of the route guidance.

As described above, the route guidance system SY of the present embodiment determines, when the route guidance of the on-board device 10 is paused, whether the distance between the present location of the vehicle and the car navigation destination (parking location) is within the predetermined distance X, which is determined depending on the car navigation destination, and if the distance is within the predetermined distance X, the destination information is transmitted to the portable device 30. Hence, whether the destination information is to be transmitted is properly determined depending on the car navigation destination. If the car navigation destination is, for example, a sightseeing spot where parking lots are distributed in a large area, then the predetermined distance X is set longer. If the car navigation destination is, for example, an urban area where parking lots are distributed around closer area of the destination, then the predetermined distance X is set shorter. As such, improved convenience may be brought to the route guidance in coordination with the portable device 30.

Moreover, the on-board device 10, upon receiving the arrival confirmation information from the portable device 30, ends the route guidance automatically, and hence an operation by the user for terminating the route guidance can be omitted on the on-board device 10. This brings further improved convenience of the route guidance in coordination with the portable device 30.

It is noted that, in the above embodiment, the distribution of parking lots around the car navigation destination is searched from the map information to determine the predetermined distance X based on the search result, however, a determination method of that may vary from determining the predetermined distance X based on the distance from the nearest parking lot to the car navigation destination, or determining the predetermined distance X based on the number of parking lots present within a certain distance from the car navigation destination.

It is further noted that the predetermined distance X may be determined in advance per car navigation destination, rather than searching the periphery of the destination from the map information. In this case, instead of the periphery information search unit 220 in the functional configuration shown in FIG. 2, a distance information memory unit (not shown) which stores each place determinable as a car navigation destination in association with distance information used as a predetermined distance may be included. The predetermined distance determination unit 120, given the determination of the car navigation destination, refers to the distance information memory unit to determine the predetermined distance based on the distance information associated with the car navigation destination. Such configuration allows for using predetermined distance as a database, and hence allows for readily (without searching the periphery of the car navigation destination) determining the predetermined distance of an appropriate length depending on the car navigation destination. It is noted that the predetermined distance may be determined by referring to the distance information memory unit at the time the route guidance is paused, rather than determining the predetermined distance when the car navigation destination is determined.

Moreover, the distance information memory unit may be disposed in an external apparatus (a server configured to be communicable with the on-board device 10). In this case, when the on-board device 10 transmits the parking location to the external apparatus, the external apparatus reads out the distance information associated with the parking location from the distance information memory unit to transmit to the on-board device 10. The on-board device 10 (the predetermined distance determination unit 120) determines a predetermined distance based on the distance information acquired from the external apparatus. Such configuration allows for not requiring the distance information memory unit inside the on-board device 10. Hence it simplifies the apparatus construction of the on-board device 10 while lowering the cost. Furthermore, the distance information memory unit may be centralized-managed in the external apparatus, and hence updating processes may be conducted easily.

Furthermore, in the above embodiment, the on-board device 10, upon the pause of the route guidance of the on-board device 10, transmits to the portable device 30 the destination information only when the conditions for transmission are satisfied. However, it may be configured such that the destination information can be transmitted at an optional timing by the user's operation to the on-board device 10. Still furthermore, it may be configured such that the destination information can be transmitted from the on-board device 10 by the user's operation on the portable device 30. In this case, the portable device 30 transmits to the on-board device 10 a transmission request for the destination information. The on-board device 10, in response to the transmission request, transmits the destination information indicating the destination for the route guidance being provided.

Moreover, in the above embodiment, certain registered places (the user's school, work place, or home) are predetermined registered places, however, it may be configured such that the places frequently visited (for example, the places set as destination over a predetermined times in the past) are studied and automatically registered as the predetermined registered places. Furthermore, the car navigation destination for which a coordination process had been canceled in the past (see S23 of FIG. 6) may be stored, and the car navigation destination may be registered as the predetermined registered place.

Still furthermore, in the above embodiment, when the portable device 30 determines that the destination has actually been reached based on the present location information acquired from the GPS receiver and etc. and the destination information received from the on-board device 10, the portable device 30 transmits the arrival confirmation information to the on-board device 10. However, it may be configured such that the arrival confirmation information is transmitted upon the user of the portable device 30 performing a predetermined operation (for example, pressing the arrival confirmation button). In this case, the portable device 30 determines that the destination has been reached regardless of whether the destination has actually been reached. Accordingly, it is convenient that the user of the portable device, regardless of whether he/she has actually arrived at the destination, may perform the predetermined operation to terminate the route guidance of the on-board device 10 when he/she no longer needs the route guidance of the on-board device 10 upon returning to the vehicle.

Moreover, in the above embodiment, the on-board device 10, when having received the arrival confirmation information from the portable device 30, may automatically end the route guidance. On the contrary, the portable device 30, when having received the arrival confirmation information from the on-board device 10, may end the route guidance of the portable device 30. Such configuration allows for saving the user's effort in terminating the route guidance function on the portable device 30, when the destination information is transmitted from the portable device 30 to the on-board device 10 and the route guidance has been transferred.

It is noted that each of the configuration elements of the on-board device 10 or the portable device 30 of the above embodiments may be provided through a computer program. It is further noted that the computer program may be stored in and provided as a recording medium (not shown in the figures). That is to say that, a computer program that makes a computer function as each of the configuration elements of the on-board device 10 and the portable device 30, and a recording medium on which the computer program is stored, are included in the scope of the claims of this invention. Else, modifications may be made arbitrarily without departing from the spirit of the invention.

### REFERENCE NUMERALS

10 ON-BOARD DEVICE
11 GPS RECEIVER
12 ANTENNA
13 AUTONOMOUS NAVIGATION SENSOR
14 DISPLAY
15 SPEAKER
16 REMOTE CONTROLLER RECEIVER
17 REMOTE CONTROLLER
18 MICROPHONE
19 COMMUNICATION SECTION
20 CONTROL SECTION
21 CPU
22 ROM
23 RAM
24 MAP DATABASE
25 PLACE REGISTRATION DATABASE
26 POWER BUTTON
28 CONNECTION BUS
30 PORTABLE DEVICE
SY ROUTE GUIDANCE SYSTEM

1. An on-board device comprising:
a destination setting unit with which a destination is set;
a route guidance unit that provides route guidance for a vehicle until a parking location that corresponds to the destination;
a destination information transmitter that transmits destination information indicating the destination to a portable device; and
an arrival confirmation information receiver that receives from the portable device arrival confirmation information indicating that the destination has been reached; wherein
the route guidance unit ends the route guidance for the vehicle to the parking location when the destination information has been transmitted or the arrival confirmation information has been received.

2. The on-board device according to claim 1, wherein the destination information transmitter sends the destination information upon pause of the route guidance for the vehicle.

3. The on-board device according to claim 1, further comprising:
a start instruction transmitter that transmits to the portable device a start instruction of a route guidance function for a person before the destination information is sent by the destination information transmitter.

4. The on-board device according to claim 1, with the portable device also having a destination setting function for setting a destination, further comprising:
a destination information receiver that receives from the portable device the destination information set by the destination setting function; and
a termination instruction transmitter that transmits to the portable device a termination instruction for terminating the route guidance function upon receiving the destination information, wherein
the destination setting unit sets the destination based on the destination information received.

5. The on-board device according to claim 1, further comprising:
a coordination selection unit with which whether to perform a coordination process with the portable device is selected, wherein
the destination information transmitter transmits the destination information when performing the coordination process is selected in the coordination selection unit.

6. The on-board device according to claim 2, further comprising:
a present location information acquisition unit that acquires present location information indicating a present location, wherein
the destination information transmitter transmits the destination information when a distance between the present location where the route guidance for the vehicle is paused and the parking location is within a predetermined distance.

7. The on-board device according to claim 6, wherein
the destination information transmitter transmits the destination information and the present location information indicating the present location where the route guidance for the vehicle is paused.

8. The on-board device according to claim 2, wherein
the route guidance unit uses an operation of turning the on-board device off or the vehicle's engine stop during the route guidance for the vehicle as a trigger to pause the route guidance, and
the destination information transmitter transmits the destination information before the on-board device is deactivated due to the operation of turning off or the engine stop.

9. The on-board device according to claim 2, wherein
the destination information transmitter transmits the destination information when the parking location is not any of pre-registered places.

10. A route guidance system comprising:
the on-board device according to claim 1; and
the portable device.

11. A method for controlling communication of an on-board device providing route guidance for a vehicle by coordinating with a portable device providing route guidance for a person, the method comprising, performed by the on-board device:
setting a destination;
providing route guidance for the vehicle until the vehicle arrives at a parking location corresponding to the destination;
transmitting destination information indicating the destination to the portable device;
receiving from the portable device arrival confirmation information indicating that the destination has been reached; and
ending the route guidance for the vehicle to the parking location after transmitting the destination information or receiving the arrival confirmation information.

12. A computer readable medium having stored thereon instructions that can be executed by a a computer to execute each step in the method for controlling communication of an on-board device according to claim 11.

13. A route guidance system comprising:
the on-board device according to claim 2; and
the portable device.

14. A route guidance system comprising:
the on-board device according to claim 3; and
the portable device.

15. A route guidance system comprising:
the on-board device according to claim 4; and
the portable device.

16. A route guidance system comprising:
the on-board device according to claim 5; and
the portable device.

17. A route guidance system comprising:
the on-board device according to claim 6; and
the portable device.

18. A route guidance system comprising:
the on-board device according to claim 7; and
the portable device.

19. A route guidance system comprising:
the on-board device according to claim 8; and
the portable device.

20. A route guidance system comprising:
the on-board device according to claim 9; and
the portable device.
